(19) United States
(12) Patent Application Publication
(10) Pub. No.: US 2026/0321507 A1
(43) Pub. Date: Oct. 15, 2026

(54) MULTILAYER CERAMIC CAPACITOR

(71) Applicant: Murata Manufacturing Co., Ltd., Nagaokakyo-shi (JP)

(72) Inventors: Shun IWATA, Nagaokakyo-shi (JP); Yasuyuki SHIMADA, Nagaokakyo-shi (JP)

(21) Appl. No.: 19/466,945

(22) Filed: Feb. 2, 2026

Related U.S. Application Data
(63) Continuation of application No. PCT/JP2024/023573, filed on Jun. 28, 2024.

(30) Foreign Application Priority Data
Aug. 7, 2023 (JP) 2023-128837

(51) Int. Cl. H01G 4/30; H01G 4/012; H01G 4/12

(52) U.S. Cl. CPC H01G 4/30; H01G 4/012; H01G 4/1227

(57) ABSTRACT

In a multilayer ceramic capacitor, when a region in which internal electrode layers overlap one another when viewed from a lamination direction is an effective portion, facing regions sandwiching the effective portion from a width direction are first and second side surface-side outer layer portions, and facing regions sandwiching the effective portion, the first and second side surface-side outer layer portions from the lamination direction are first and second main surface-side outer layer portions, a porosity Pw (%) of the first or second side surface-side outer layer portions, and a porosity Pwt (%) of the first or second main surface-side outer layer portions satisfy about 1.6≤Pwt−Pw≤about 3.1.

### CROSS REFERENCE TO RELATED APPLICATIONS

This application claims the benefit of priority to Japanese Patent Application No. 2023-128837 filed on Aug. 7, 2023 and is a Continuation Application of PCT Application No. PCT/JP2024/023573 filed on Jun. 28, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

Conventionally, multilayer ceramic capacitors widely used in electronic devices such as mobile phones and portable music players each include an inner layer portion that includes a stack of a plurality of dielectric layers made of ceramic material and a plurality of internal electrode layers to generate capacitance, outer layer portions provided on both sides of the inner layer portion in a lamination direction, and side margin portions provided on both sides of the inner layer portion in a width direction.

With the recent reduction in size and improvement in performance of electronic devices, multilayer ceramic capacitors are also required to be reduced in size and increased in capacitance. In order to achieve a reduction in size and an increase in capacitance in multilayer ceramic capacitors, a reduced thickness of the side margin portions and an increased area of the internal electrode layers can be considered. However, when the thickness of the side margin portions is reduced, resistance to moisture penetrating between the lateral surfaces of the multilayer body and the external electrodes and reaching the internal electrode layers at the end surfaces of the multilayer body, that is, moisture resistance, is reduced, and as a result, the reliability may be reduced.

Therefore, there is a need to develop multilayer ceramic capacitors that have high reliability while achieving a reduction in size and increase in capacitance.

### SUMMARY OF THE INVENTION

Example embodiments of the present invention provide multilayer ceramic capacitors each with high reliability while achieving a reduction in size and an increase in capacitance.

The inventors of example embodiments of the present invention have discovered that, in a multilayer ceramic capacitor including a multilayer body including a plurality of dielectric layers and a plurality of internal electrode layers that are laminated, and external electrodes electrically conductive with the internal electrode layers, when the pore ratio Pw of the first lateral surface-side outer layer portion or the second lateral surface-side outer layer portion and the pore ratio Pwt of the first main surface-side outer layer portion or the second main surface-side outer layer portion are adjusted to have a predetermined relationship, moisture resistance is improved and high reliability can be obtained, while achieving a reduction in size and an increased capacitance.

An example embodiment of the present invention provides a multilayer ceramic capacitor which includes a multilayer body including a plurality of dielectric layers and a plurality of internal electrode layers that are laminated, and external electrodes each being electrically conductive with the internal electrode layers. The multilayer body includes a first main surface and a second main surface opposed to each other in a lamination direction in which the plurality of dielectric layers and the plurality of internal electrode layers are laminated, a first lateral surface and a second lateral surface opposed to each other in a width direction that intersects both the lamination direction and a length direction in which each of the plurality of internal electrode layers extends toward a corresponding one of the external electrodes, and a first end surface and a second end surface opposed to each other in the length direction that intersects the lamination direction and the width direction. Each of the external electrodes is on one of the first end surface or the second end surface. In the multilayer body, when a region where the plurality of internal electrode layers overlap each other when viewed in the lamination direction is an effective portion, opposing regions sandwiching the effective portion in the width direction are a first lateral surface-side outer layer portion and a second lateral surface-side outer layer portion, opposing regions sandwiching the effective portion in the length direction are a first end surface-side outer layer portion and a second end surface-side outer layer portion, and opposing regions sandwiching the effective portion, the first lateral surface-side outer layer portion, the second lateral surface-side outer layer portion, the first end surface-side outer layer portion, and the second end surface-side outer layer portion in the lamination direction are a first main surface-side outer layer portion and a second main surface-side outer layer portion, a pore ratio Pw (%) of the first lateral surface-side outer layer portion or the second lateral surface-side outer layer portion and a pore ratio Pwt (%) of the first main surface-side outer layer portion or the second main surface-side outer layer portion satisfy about 1.6≤Pwt−Pw≤about 3.1.

According to example embodiments of the present invention, even when a reduction in size and an increased capacitance are achieved, moisture penetration from outside is prevented by providing lateral surface-side outer layer portions of the multilayer body with a dense dielectric, such that multilayer ceramic capacitors each with high moisture resistance reliability are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view of a multilayer ceramic capacitor 1 according to an example embodiment of the present invention.

FIG. 2 is a cross-sectional view of the multilayer ceramic capacitor 1 taken along the line II-II shown in FIG. 1.

FIG. 3 is a cross-sectional view of the multilayer ceramic capacitor 1 taken along the line III-III shown in FIG. 1.

FIG. 4 is a cross-sectional view of the multilayer ceramic capacitor 1 taken along the line IV-IV shown in FIG. 3.

FIG. 5 is a cross-sectional view of the multilayer ceramic capacitor 1 taken along the line V-V shown in FIG. 3.

FIG. 6 is an exploded perspective view for explaining a lamination state of a multilayer body 10 of a multilayer ceramic capacitor 1 according to an example embodiment of the present invention.

FIG. 7 is a flowchart for explaining an example of a manufacturing method of a multilayer ceramic capacitor 1 according to an example embodiment of the present invention.

FIG. 8 is a perspective view of a material sheet 203 on which an internal electrode layer pattern 103 defining and functioning as an internal electrode layer 30 of a multilayer ceramic capacitor 1 according to an example embodiment of the present invention is printed on the surface of a ceramic green sheet 101.

FIG. 9 is a perspective view showing a state where ceramic paste 102 is provided on a material sheet 203.

FIG. 10 is a diagram for explaining a lamination state of the material sheet 203.

### DETAILED DESCRIPTION OF THE EXAMPLE EMBODIMENTS

Multilayer ceramic capacitors will be described as example embodiments of the present invention, but the present invention is not limited thereto. Also, the drawings may be schematically simplified to explain the content of example embodiments of the present invention, and the ratio of dimensions of the components or between components depicted may not match the ratio of their dimensions described in the specification. Also, components described in the specification may be omitted in the drawings, or the number of components may be reduced in the drawings.

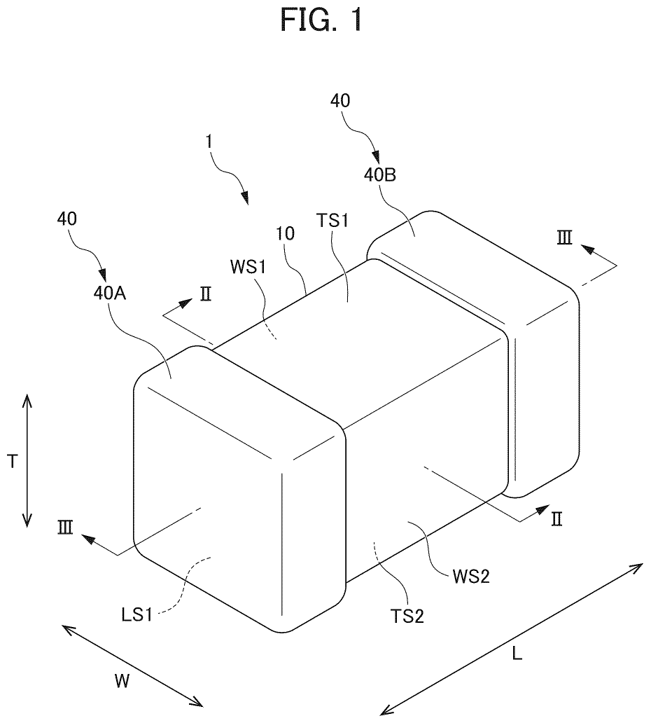

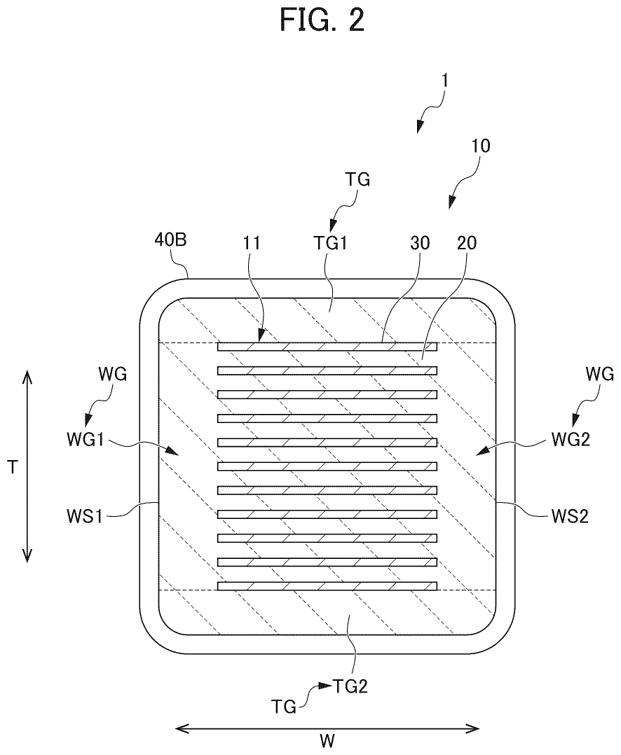

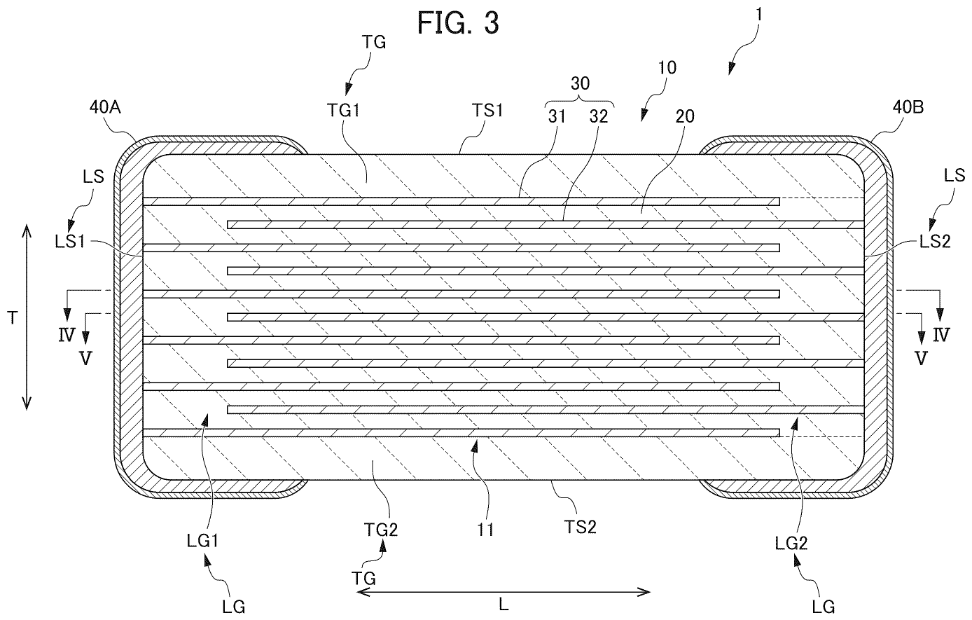

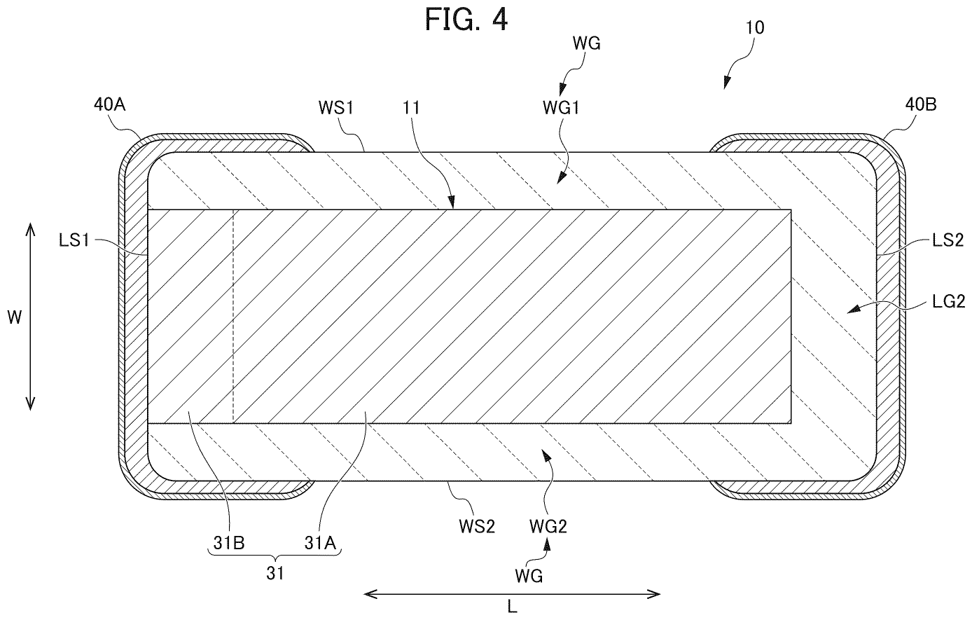

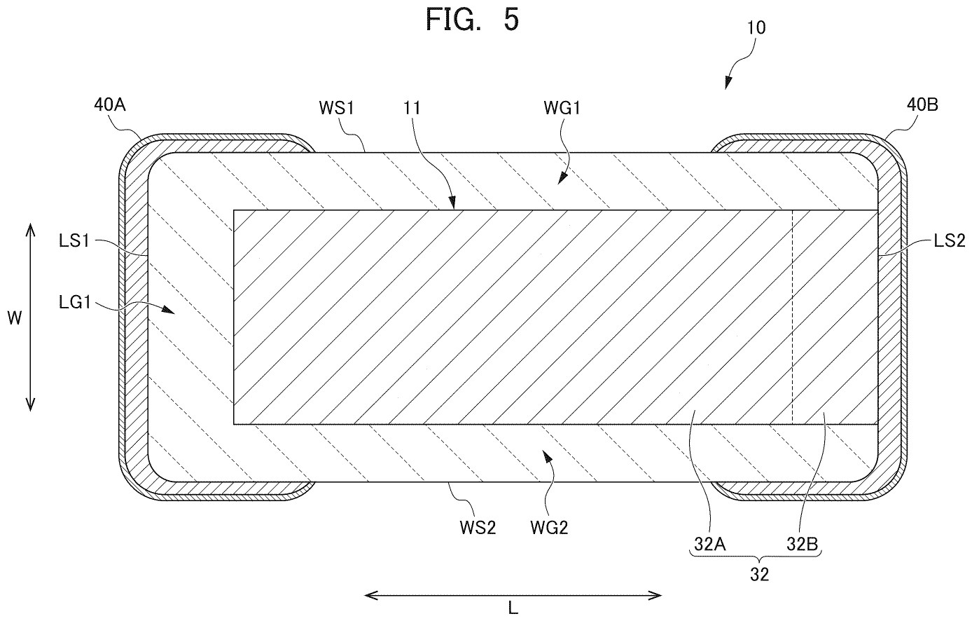

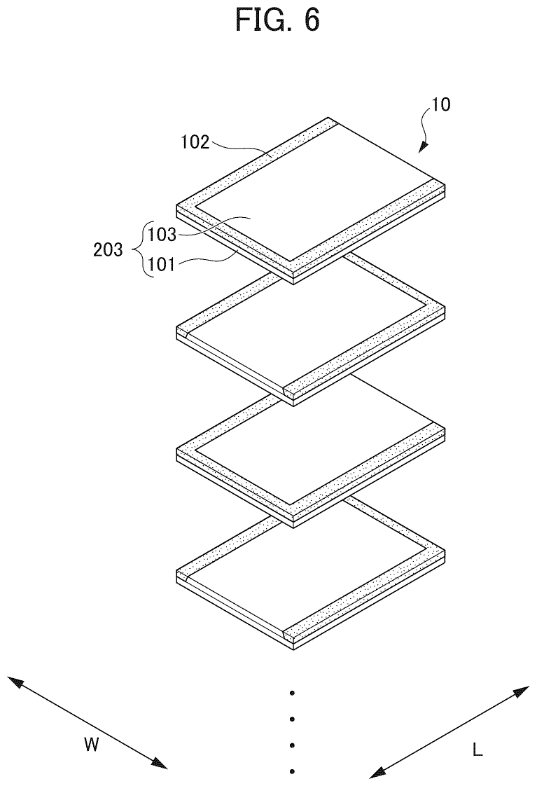

FIG. 1 is a schematic perspective view of a multilayer ceramic capacitor 1 according to an example embodiment of the present invention. FIG. 2 is a cross-sectional view of the multilayer ceramic capacitor 1 taken along the line II-II shown in FIG. 1. FIG. 3 is a cross-sectional view of the multilayer ceramic capacitor 1 taken along the line III-III shown in FIG. 1. FIG. 4 is a cross-sectional view of the multilayer ceramic capacitor 1 taken along the line IV-IV shown in FIG. 3. FIG. 5 is a cross-sectional view of the multilayer ceramic capacitor 1 taken along the line V-V shown in FIG. 3. FIG. 6 is an exploded perspective view for explaining a lamination state of the multilayer body 10 of the multilayer ceramic capacitor 1. The line II-II passes through a middle portion of the multilayer ceramic capacitor 1 in the length direction L described later, and the line III-III passes through the middle portion in the width direction W described later.

In the following description, as terms expressing the orientation of the multilayer ceramic capacitor 1, a direction in which the pair of external electrodes 40 are provided is defined as the length direction L. A direction in which the dielectric layers 20 and the internal electrode layers 30 are laminated is defined as the lamination direction T. A direction intersecting both the length direction L and the lamination direction T is defined as the width direction W. In the example embodiments, the length direction L, the lamination direction T, and the width direction W are orthogonal or substantially orthogonal to each other. The cross section shown in FIG. 2 is also referred to as a WT cross section because it is parallel or substantially parallel to the width direction W and the lamination direction T. The cross section shown in FIG. 3 is also referred to as an LT cross section because it is parallel or substantially parallel to the length direction L and the lamination direction T. The cross sections shown in FIGS. 4 and 5 are also referred to as LW cross sections because they are parallel or substantially parallel to the length direction L and the width direction W.

The multilayer ceramic capacitor 1 includes a multilayer body 10 including a plurality of dielectric layers 20 and a plurality of internal electrode layers 30 that are laminated, and a pair of external electrodes 40 provided at both ends of the multilayer body 10.

The multilayer body 10 has a rectangular or substantially rectangular parallelepiped shape. It is preferable that the corner portions and ridge portions of the multilayer body 10 are rounded. The corner portions are portions where three surfaces of the multilayer body intersect, and the ridge portions are portions where two surfaces of the multilayer body intersect. The dimension of the multilayer body 10 in the length direction L is not necessarily longer than the dimension in the width direction W. Also, irregularities may be provided on a portion or all of the surfaces of the multilayer body 10.

The dimensions of the multilayer body 10 are not particularly limited, but when the dimension in the length direction L of the multilayer body 10 is defined as an L dimension, the L dimension is preferably, for example, about 0.2 mm or more and about 10 mm or less. Also, when the dimension in the lamination direction T of the multilayer body 10 is defined as a T dimension, the T dimension is preferably, for example, about 0.1 mm or more and about 10 mm or less. Further, when the dimension in the width direction W of the multilayer body 10 is defined as a W dimension, the W dimension is preferably, for example, about 0.1 mm or more and about 10 mm or less.

As shown in FIGS. 1 to 3, the multilayer body 10 includes a first main surface TS1 and a second main surface TS2 opposed to each other in the lamination direction T, a first lateral surface WS1 and a second lateral surface WS2 opposed to each other in the width direction W intersecting the lamination direction T, and a first end surface LS1 and a second end surface LS2 opposed to each other in the length direction L intersecting the lamination direction T and the width direction W.

The plurality of dielectric layers 20 laminated in the multilayer body 10 may be made of ceramic material, for example. As the ceramic material, for example, a dielectric ceramic having BaTiO₃ as a main component may be used. Also, as the ceramic material, a material obtained by adding at least one secondary component such as, for example, a Mn compound, Fe compound, Cr compound, Co compound, or Ni compound to these main components may be used.

The thickness of the dielectric layer 20 is preferably, for example, about 0.5 μm or more and about 72 μm or less. The number of the dielectric layers 20 to be laminated is preferably, for example, 10 or more and 700 or less. The number of the dielectric layers 20 is the total number of the dielectric layers of the effective portion 11 and the dielectric layers of the main surface-side outer layer portion TG including the first main surface-side outer layer portion TG1 and the second main surface-side outer layer portion TG2.

The plurality of internal electrode layers 30 laminated in the multilayer body 10 include first internal electrode layers 31 and second internal electrode layers 32. The plurality of first internal electrode layers 31 are each provided on a corresponding one of the plurality of dielectric layers 20, and similarly, the plurality of second internal electrode layers 32 are each provided on a corresponding one of the plurality of dielectric layers 20. The plurality of first internal electrode layers 31 and the plurality of second internal electrode layers 32 are alternately provided in the lamination direction T of the multilayer body 10.

Each of the first internal electrode layers 31 includes a first counter portion 31A opposed to a corresponding one of the second internal electrode layers 32, and a first extension portion 31B extending from the first counter portion 31A toward the first end surface LS1. The first extension portion 31B is exposed at the first end surface LS1.

Each of the second internal electrode layers 32 includes a second counter portion 32A opposed to a corresponding one of the first internal electrode layers 31, and a second extension portion 32B extending from the second counter portion 32A toward the second end surface LS2. The second extension portion 32B is exposed at the second end surface LS2.

The first internal electrode layers 31 and the second internal electrode layers 32 include appropriate electrically conductive materials such as, for example, metals such as Ni, Cu, Ag, Pd, or Au, alloys including at least one of these metals, or the like. When an alloy is used, the first internal electrode layers 31 and the second internal electrode layers 32 may include, for example, an Ag—Pd alloy.

The thickness of each of the first internal electrode layers 31 and the second internal electrode layers 32 is preferably, for example, about 0.2 μm or more and about 3.0 μm or less. The total number of the first internal electrode layers 31 and the second internal electrode layers 32 is preferably, for example, five or more and 350 or less.

The external electrodes 40 include a first external electrode 40A and a second external electrode 40B.

The first external electrode 40A is provided adjacent to the first end surface LS1. The first external electrode 40A is connected to the first internal electrode layers 31. The first external electrode 40A is provided on the first end surface LS1, but may be provided on at least one of the first main surface TS1, the second main surface TS2, the first lateral surface WS1, and the second lateral surface WS2 in addition to on the first end surface LS1. In the present example embodiment, the first external electrode 40A is provided on a portion of the first main surface TS1, a portion of the second main surface TS2, a portion of the first lateral surface WS1, and a portion of the second lateral surface WS2, in addition to on the first end surface LS1. The first external electrode 40A may extend, for example, from the first end surface LS1 to either the first main surface TS1 or the second main surface TS2. That is, the cross-sectional shape of the first external electrode 40A may be L-shaped (not shown).

The second external electrode 40B is provided adjacent to the second end surface LS2. The second external electrode 40B is connected to the second internal electrode layers 32. The second external electrode 40B is provided on the second end surface LS2, but, may be provided on at least one of the first main surface TS1, the second main surface TS2, the first lateral surface WS1, and the second lateral surface WS2 in addition to on the second end surface LS2. In the present example embodiment, the second external electrode 40B is provided on a portion of the first main surface TS1, a portion of the second main surface TS2, a portion of the first lateral surface WS1, and a portion of the second lateral surface WS2, in addition to on the second end surface LS2. The second external electrode 40B may extend, for example, from the second end surface LS2 to either the first main surface TS1 or the second main surface TS2. That is, the cross-sectional shape of the second external electrode 40B may be L-shaped (not shown).

In the multilayer body 10, capacitance is generated by the first counter portions 31A of the first internal electrode layer 31 and the second counter portions 32A of the second internal electrode layer 32 opposing each other with the dielectric layers 20 interposed therebetween. Therefore, the function of the capacitor is provided between the first external electrode 40A to which the first internal electrode layers 31 are connected and the second external electrode 40B to which the second internal electrode layers 32 are connected.

The first external electrode 40A and the second external electrode 40B each may include, for example, a base electrode layer and a plated layer provided on the base electrode layer. The base electrode layer is formed by applying an electrically conductive paste including a metal component and a glass component to the first end surface LS1 and the second end surface LS2 of the multilayer body 10, and then firing the resultant product. As the metal component to be blended in the electrically conductive paste, for example, metals such as Cu, Ni, Ag, Pd, or Au, or alloys such as Ag and Pd can be used.

The plated layer provided on the base electrode layer includes, for example, at least one of a metal such as Cu, Ni, Ag, Pd, or Au, or an alloy of Ag, Pd or the like. The plated layer may include, for example, a two-layer configuration including a Ni plated layer and a Sn plated layer. However, the plated layer may include a single layer or multiple layers.

The multilayer body 10 includes, as regions defining the multilayer body 10, an effective portion 11 where the internal electrode layers 30 overlap with each other when viewed from the lamination direction T to generate capacitance, main surface-side outer layer portions TG sandwiching the effective portion 11 from the lamination direction T, lateral surface-side outer layer portions WG sandwiching the effective portion 11 from the width direction W intersecting the lamination direction T, and end surface-side outer layer portions LG sandwiching the effective portion 11 from the length direction L intersecting the lamination direction T and the width direction W.

The effective portion 11 is a portion that generates capacitance and substantially defines and functions as a capacitor by the first counter portions 31A of the first internal electrode layers 31 and the second counter portions 32A of the second internal electrode layers 32 opposing each other with the dielectric layers 20 interposed therebetween in the multilayer body 10.

The lateral surface-side outer layer portion WG includes a first lateral surface-side outer layer portion WG1 and a second lateral surface-side outer layer portion WG2. The first lateral surface-side outer layer portion WG1 is positioned between the active portion 11 and the first lateral surface WS1, and is a portion that includes the dielectric layer 20. The second lateral surface-side outer layer portion WG2 is positioned between the active portion 11 and the second lateral surface WS2, and is a portion that includes the dielectric layer 20. FIG. 2 shows the ranges of the first lateral surface-side outer layer portion WG1 and the second lateral surface-side outer layer portion WG2 in the WT cross section of the multilayer ceramic capacitor 1. The lateral surface-side outer layer portion WG is also referred to as a W gap, side gap, or side margin portion.

The end surface-side outer layer portion LG includes a first end surface-side outer layer portion LG1 and a second end surface-side outer layer portion LG2. The first end surface-side outer layer portion LG1 is positioned between the active portion 11 and the first end surface LS1, and is a portion that includes the dielectric layer 20. The second end surface-side outer layer portion LG2 is positioned between the active portion 11 and the second end surface LS2, and is a portion that includes the dielectric layer 20. FIG. 3 shows the ranges of the first end surface-side outer layer portion LG1 and the second end surface-side outer layer portion LG2 in the LT cross section of the multilayer ceramic capacitor 1. The end surface-side outer layer portion LG is also referred to as an L gap, end gap, or end margin portion.

The multilayer body 10 includes main surface-side outer layer portions TG including a first main surface-side outer layer portion TG1 and a second main surface-side outer layer portion TG2 in regions opposing each other that sandwich the active portion 11, the first lateral surface-side outer layer portion WG1, the second lateral surface-side outer layer portion WG2, the first end surface-side outer layer portion LG1, and the second end surface-side outer layer portion LG2, from the lamination direction T.

The first main surface-side outer layer portion TG1 is located adjacent to the first main surface TS1 of the multilayer body 10. The first main surface-side outer layer portion TG1 can be formed by laminating a plurality of dielectric layers 20 as ceramic layers positioned between the first main surface TS1 and an internal electrode layer 30 closest to the first main surface TS1. The dielectric layer 20 used in the first main surface-side outer layer portion TG1 may be the same as the dielectric layer 20 used in the active portion 11.

The second main surface-side outer layer portion TG2 is located adjacent to the second main surface TS2 of the multilayer body 10. The second main surface-side outer layer portion TG2 can be formed by laminating a plurality of dielectric layers 20 as ceramic layers positioned between the second main surface TS2 and an internal electrode layer 30 closest to the second main surface TS2. The dielectric layer 20 used in the second main surface-side outer layer portion TG2 may be the same as the dielectric layer 20 used in the active portion 11.

The pore ratio Pw (%) of the first lateral surface-side outer layer portion or the second lateral surface-side outer layer portion and the pore ratio Pwt (%) of the first main surface-side outer layer portion or the second main surface-side outer layer portion satisfy the following expression (1):

about 1.6≤Pwt−Pw≤about 3.1 (1)

The pore ratio Pw of the first lateral surface-side outer layer portion WG1 or the second lateral surface-side outer layer portion WG2 can be obtained by targeting a WT cross section of a region located at the middle in the width direction W and at the middle in the lamination direction T of the first lateral surface-side outer layer portion WG1 positioned between the active portion 11 and the first lateral surface WS1 or the second lateral surface-side outer layer portion WG2 positioned between the active portion 11 and the second lateral surface WS2, and calculating the ratio of the area occupied by pores in this WT cross section. As an example of a specific method, the targeted WT cross section is imaged by a scanning electron microscope (SEM), the area of the field of view and the area occupied by the pores are obtained from analysis of the captured SEM image, and the pore ratio Pw (%) can be calculated by the formula: pore ratio Pw (%)=area occupied by pores/area of field of view×100.

Further, the pore ratio Pwt of the first main surface-side outer layer portion TG1 or the second main surface-side outer layer portion TG2 can be obtained by targeting a WT cross section of a region located in the lamination direction T from the region where the pore ratio Pw of the first lateral surface-side outer layer portion WG1 positioned between the active portion 11 and the first lateral surface WS1 or the second lateral surface-side outer layer portion WG2 positioned between the active portion 11 and the second lateral surface WS2 is measured, and located at the middle of the thickness in the lamination direction T of the first main surface-side outer layer portion TG1 or the second main surface-side outer layer portion TG2, and calculating the ratio of the area occupied by pores in such WT cross section. As an example of a specific method, the targeted WT cross section is imaged by a scanning electron microscope (SEM), the area of the field of view and the area occupied by the pores are obtained from analysis of the captured SEM image, and the pore ratio Pwt (%) can be calculated by the formula: pore ratio Pwt (%)=area occupied by pores/area of field of view×100.

As shown in expression (1), by making the pore ratio Pw smaller than the pore ratio Pwt by a predetermined amount to raise the density of the dielectric layers 20 in the first lateral surface-side outer layer portion WG1 or the second lateral surface-side outer layer portion WG2, it is possible to reduce or prevent moisture penetration from the outside and improve moisture resistance.

The pore ratio Pl (%) of the first end surface-side outer layer portion or the second end surface-side outer layer portion and the pore ratio Plt (%) of the first main surface-side outer layer portion or the second main surface-side outer layer portion satisfy the following expression (2):

about 1.6≤Plt−Pl≤about 3.1 (2)

The pore ratio Pl of the dielectric of the first end surface-side outer layer portion LG1 or the second end surface-side outer layer portion LG2 can be obtained by targeting an LT cross section of a dielectric region located at the middle in the length direction L and at the middle in the lamination direction T of the first end surface-side outer layer portion LG1 positioned between the active portion 11 and the first end surface LS1 or the second end surface-side outer layer portion LG2 positioned between the active portion 11 and the second end surface LS2, and calculating the ratio of the area occupied by pores in this LT cross section. As an example of a specific method, the targeted LT cross section is imaged by a scanning electron microscope (SEM), the area of the field of view and the area occupied by the pores are obtained from analysis of the captured SEM image, and the pore ratio Pl (%) can be calculated by the formula: pore ratio Pl (%) =area occupied by pores/area of field of view×100.

Further, the pore ratio Plt of the first main surface-side outer layer portion TG1 or the second main surface-side outer layer portion TG2 can be obtained by targeting an LT cross section of a region located in the lamination direction T from the region where the pore ratio Pl of the dielectric in the first end surface-side outer layer portion LG1 positioned between the active portion 11 and the first end surface LS1 or the second end surface-side outer layer portion LG2 positioned between the active portion 11 and the second end surface LS2 is measured, and located at the middle of the thickness in the lamination direction T of the first main surface-side outer layer portion TG1 or the second main surface-side outer layer portion TG2, and calculating the ratio of the area occupied by pores in this LT cross section. As an example of a specific method, the targeted LT cross section is imaged by a scanning electron microscope (SEM), the area of the field of view and the area occupied by the pores are obtained from analysis of the captured SEM image, and the pore ratio Plt (%) can be calculated by the formula: pore ratio Plt (%)=area occupied by pores/area of field of view×100.

As shown in expression (2), by making the pore ratio Pl smaller than the pore ratio Plt by a predetermined amount to raise the density of the dielectric layers 20 in the first end surface-side outer layer portion LG1 or the second end surface-side outer layer portion LG2, it is possible to reduce or prevent moisture penetration from the outside and improve moisture resistance.

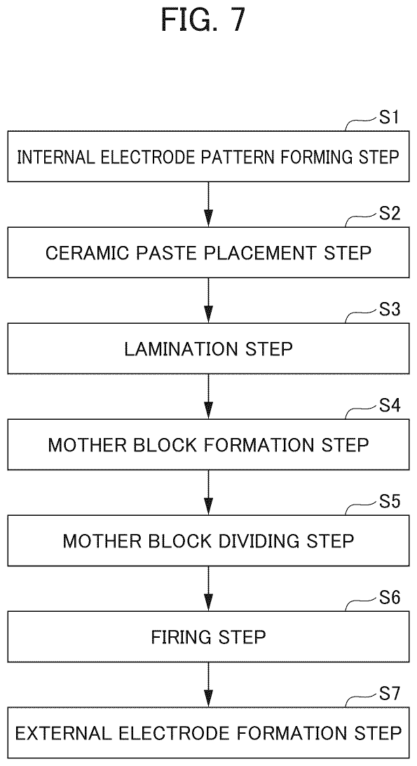

Next, an example of a manufacturing method of the multilayer ceramic capacitor 1 according to an example embodiment of the present invention will be described. FIG. 7 is a flowchart for explaining the manufacturing method of the multilayer ceramic capacitor 1 of the present example embodiment.

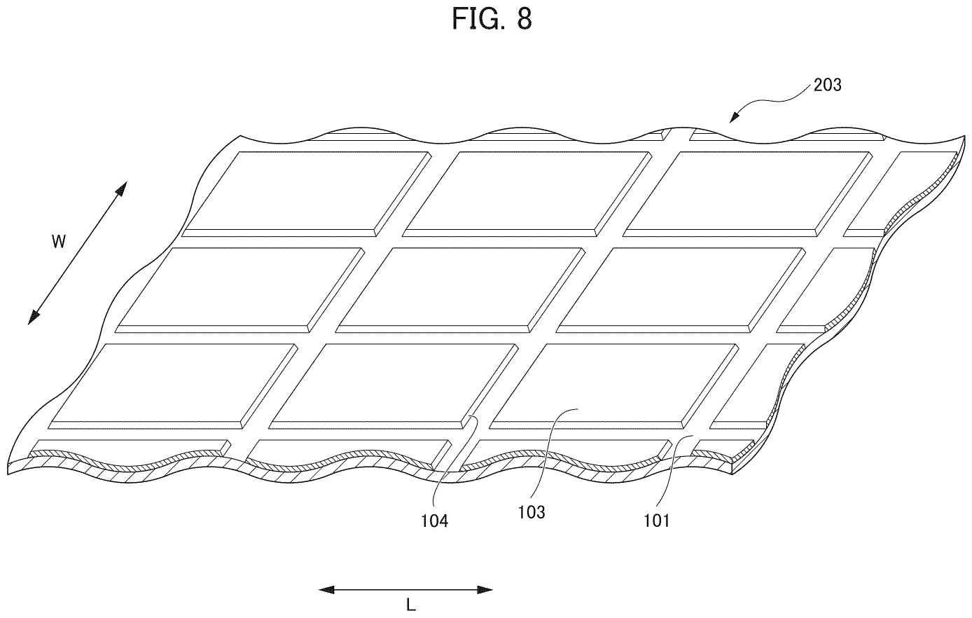

First, an internal electrode layer pattern 103 defining and functioning as the internal electrode layer 30 is formed on a ceramic green sheet 101 defining and functioning as the dielectric layer 20 using an electrically conductive paste. FIG. 8 is a perspective view of a material sheet 203 on which an internal electrode layer pattern 103 defining and functioning as the internal electrode layer 30 is printed on the surface of the ceramic green sheet 101.

The ceramic green sheet 101 is a strip-shaped sheet formed by molding a ceramic slurry containing ceramic powder, binder, and solvent into a sheet shape on a carrier film using, for example, a die coater, gravure coater, microgravure coater, or the like.

The internal electrode layer pattern 103 is formed by, for example, printing such as screen printing, gravure printing, or relief printing.

Here, the internal electrode layer pattern 103 forms step differences 104 on the ceramic green sheet 101 due to its thickness. In the example embodiments, each of the step differences 104 is a sloped surface.

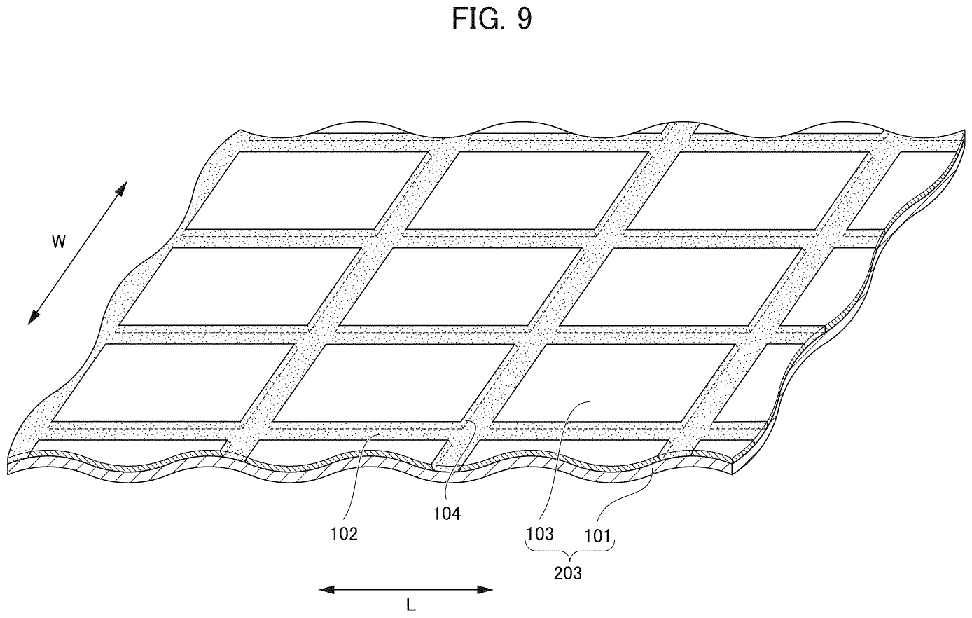

Next, the ceramic paste 102 for forming a dielectric layer is placed on the material sheet 203 so as to fill the step differences 104 due to the thickness of the internal electrode layer pattern 103. FIG. 9 is a perspective view showing a state where the ceramic paste 102 is placed on the material sheet 203.

The ceramic paste 102 includes, for example, a lower content of polyvinyl chloride (PVC) and a relatively higher content of ceramic than the ceramic slurry for forming the ceramic green sheet 101 and an upper outer layer portion ceramic green sheet 212 and a lower outer layer portion ceramic green sheet 213 described later. Therefore, when fired in the firing step S6 described later, dense dielectric layers are formed in the lateral surface-side outer layer portion WG and the end surface-side outer layer portion LG of the multilayer body 10 to which the ceramic paste 102 is applied. Accordingly, the pore ratio Pw of the lateral surface-side outer layer portion WG and the pore ratio Pl of the end surface-side outer layer portion LG can be reduced lower than the pore ratios Pwt and Plt in the main surface-side outer layer portion TG.

The ceramic paste 102 is applied, for example, by printing such as screen printing, gravure printing or relief printing. The thickness of the ceramic paste 102 is preferably, for example, about 0.4 times or more and about 0.8 times or less the thickness of the ceramic green sheet 101.

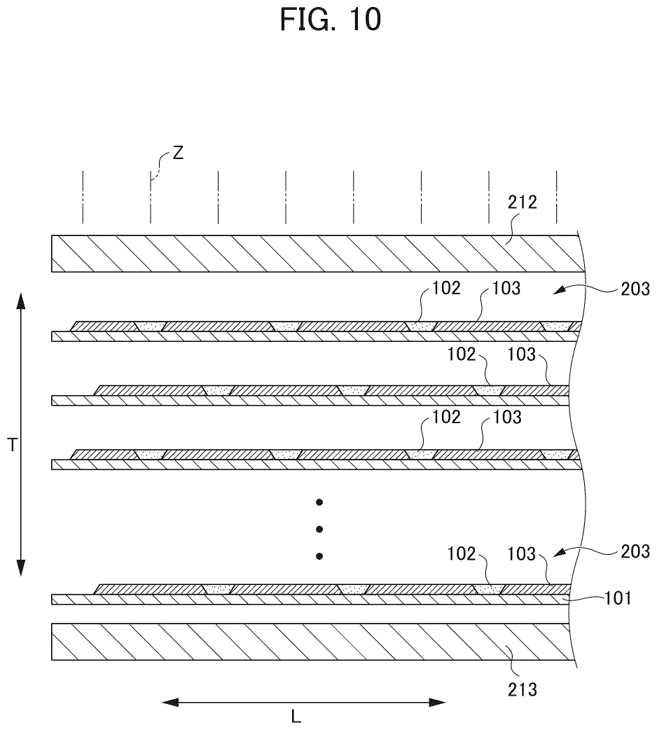

FIG. 10 is a diagram for explaining the lamination state of the material sheet 203. As shown in FIG. 10, the material sheet 203 is arranged such that adjacent internal electrode layer patterns 103 in the lamination direction T are alternately offset in the length direction L.

Furthermore, the upper outer layer portion ceramic green sheet 212 defining and functioning as the first main surface-side outer layer portion TG1 is laminated on one side of the plurality of material sheets 203 that are stacked, and the lower outer layer portion ceramic green sheet 213 defining and functioning as the second main surface-side outer layer portion TG2 is stacked on the other side thereof.

Next, the upper outer layer portion ceramic green sheet 212, the plurality of material sheets 203 that are stacked, and the lower outer layer portion ceramic green sheet 213 are subjected to hydrostatic pressing to form a mother block.

Next, the mother block is cut at the positions Z shown in FIG. 10. Although only the cutting positions Z in the length direction L are shown, the multilayer body 10 is also cut at predetermined cutting positions in the width direction W extending in a direction perpendicular or substantially perpendicular to the position Z extending in the width direction, such that a plurality of rectangular or substantially rectangular multilayer bodies 10 before firing are manufactured.

FIG. 6 is an exploded perspective view schematically illustrating the laminated state of the dielectric layers 20 and the internal electrode layers 30 in the multilayer body 10. During manufacturing of the multilayer ceramic capacitor 1, the ceramic paste 102 is printed on regions of the material sheet 203 where internal electrode layer patterns 103 are not provided. The material sheet 203 includes the internal electrode layer patterns 103 that define and function as the internal electrode layers 30 printed on ceramic green sheets 101 that define and function as the dielectric layers 20. Such material sheets 203 including the internal electrode layer patterns 103 and the ceramic paste 102 printed on the ceramic green sheets 101 are laminated and fired in the firing step S6 described later to manufacture the multilayer body 10.

Since the ceramic paste 102 is applied around the internal electrode layer patterns 103, even when pressed from the lamination direction T during lamination, the periphery of the internal electrode layer patterns 103 does not extend, such that it is possible to maintain the shape of the internal electrode layer patterns 103. Therefore, when viewing a cross section of the multilayer body 10 parallel or substantially parallel to the width direction W and the lamination direction T at the middle portion in the length direction L, the length in the width direction of the range where respective one-side ends of the internal electrode layers 30 are provided adjacent to each other in the width direction W can be, for example, about 1 μm or more and about 15 μm or less. This makes it possible to accurately form the effective portion 11 that generates capacitance, such that it is possible to enable a reduction in size and an increase in capacitance of the multilayer ceramic capacitor 1.

Furthermore, when viewing the multilayer body 10 in a cross section parallel or substantially parallel to the width direction W and the lamination direction T at the middle portion in the length direction L, a length Ew in the width direction W of an internal electrode layer 30 located at the middle portion in the lamination direction T, and a length Es in the width direction W of an internal electrode layer 30 closest to the first main surface TS1 or the second main surface TS2 satisfy the following expression (3) for Es/Ew×100 (%)L

about 95≤Es/Ew×100≤about 101 (3)

By providing the ceramic paste 102 and filling the step differences 104 due to the thickness of the internal electrode layer patterns 103, it is possible to reduce or prevent flow of the internal electrode layer patterns 103 during press processing. By reducing or preventing the flow of the internal electrode layer patterns 103 in this manner, it is possible to control the width dimension of the effective portion 11 and satisfy the expression (3). Furthermore, by satisfying the expression (3), it is possible to reduce the volume of the lateral surface-side outer layer portions WG and secure a large effective portion 11.

In the firing step, each of the multilayer chips is subjected to debinding treatment and firing treatment to form the base body. Through the firing treatment, the electrically conductive paste layer and the green sheet for manufacturing the dielectric layer are cofired to be the internal electrode layers 30 and the dielectric layers 20, respectively. The conditions for the debinding treatment can be determined according to the type of organic binder contained in the green sheet and the electrically conductive paste layer. In addition, the firing treatment is required to be performed at a temperature at which the multilayer chip is sufficiently densified. The firing temperature is preferably, for example, about 900° C. to about 1400° C., depending on the materials of the dielectric and internal electrode layers.

In the external electrode formation step, the external electrodes 40 are formed on the multilayer body 10 to manufacture the multilayer ceramic capacitor 1. The formation of the external electrodes 40 can be performed using known techniques. For example, a base electrode layer, an electrically conductive resin layer, or a direct plated layer is formed on the end surface LS where the internal electrode layers 30 of the multilayer body 10 extend toward and are exposed, and further, a plated layer is provided as needed. In the present example embodiment, for example, a Ni plated layer and a Sn plated layer are formed on the fired layer. The Ni plated layer and Sn plated layer are sequentially formed by, for example, a barrel plating method. With such a configuration, it is possible to manufacture multilayer ceramic capacitors.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of dielectric layers and a plurality of internal electrode layers that are laminated; and
external electrodes each being electrically conductive with the internal electrode layers; wherein
the multilayer body includes a first main surface and a second main surface opposed to each other in a lamination direction in which the plurality of dielectric layers and the plurality of internal electrode layers are laminated, a first lateral surface and a second lateral surface opposed to each other in a width direction intersecting both of the lamination direction and a length direction in which each of the plurality of internal electrode layers extends toward a corresponding one of the external electrodes, and a first end surface and a second end surface opposed to each other in the length direction intersecting the lamination direction and the width direction;
each of the external electrodes is located on one of the first end surface or the second end surface;
in the multilayer body, when a region where the plurality of internal electrode layers overlap each other when viewed in the lamination direction is an effective portion, opposing regions sandwiching the effective portion in the width direction are a first lateral surface-side outer layer portion and a second lateral surface-side outer layer portion, opposing regions sandwiching the effective portion in the length direction are a first end surface-side outer layer portion and a second end surface-side outer layer portion, and opposing regions sandwiching the effective portion, the first lateral surface-side outer layer portion, the second lateral surface-side outer layer portion, the first end surface-side outer layer portion, and the second end surface-side outer layer portion in the lamination direction are a first main surface-side outer layer portion and a second main surface-side outer layer portion, a pore ratio Pw (%) of the first lateral surface-side outer layer portion or the second lateral surface-side outer layer portion and a pore ratio Pwt (%) of the first main surface-side outer layer portion or the second main surface-side outer layer portion satisfy about 1.6≤Pwt−Pw≤about 3.1.

2. The multilayer ceramic capacitor according to claim 1, wherein, when the multilayer body is viewed in a cross section parallel or substantially parallel to the width direction and the lamination direction at a middle portion in the length direction, a length in the width direction of a range where respective one-side ends of the plurality of internal electrode layers in the width direction are aligned is about 1 μm or more and about 15 μm or less.

3. The multilayer ceramic capacitor according to claim 1, wherein, when the multilayer body is viewed in a cross section parallel or substantially parallel to the width direction and the lamination direction at a middle portion in the length direction, a length Ew in the width direction of one of the plurality of internal electrode layers at a middle portion in the lamination direction and a length Es in the width direction of one of the plurality of internal electrode layers closest to the first main surface or the second main surface satisfy about 95≤Es/Ew×100≤about 101.

4. The multilayer ceramic capacitor according to claim 1, wherein
a dimension in the length direction of the multilayer body is about 0.2 mm or more and about 10 mm or less;
a dimension in the lamination direction of the multilayer body is about 0.1 mm or more and about 10 mm or less; and
a dimension in the width direction of the multilayer body is about 0.2 mm or more and about 10 mm or less.

5. The multilayer ceramic capacitor according to claim 1, wherein each of the plurality of dielectric layers includes BaTiO₃ as a main component.

6. The multilayer ceramic capacitor according to claim 5, wherein each of the plurality of dielectric layers includes a Mn compound, Fe compound, Cr compound, Co compound, or Ni compound as a secondary component.

7. The multilayer ceramic capacitor according to claim 1, wherein a thickness of each of the plurality of dielectric layers is about 0.5 μm or more and about 72 μm or less.

8. The multilayer ceramic capacitor according to claim 1, wherein each of the plurality of internal electrode layers includes at least one of Ni, Cu, Ag, Pd, or Au, or an alloy including at least one of Ni, Cu, Ag, Pd, or Au.

9. The multilayer ceramic capacitor according to claim 1, wherein a thickness of each of the plurality of internal electrode layers is about 0.2 μm or more and about 3.0 μm or less.

10. The multilayer ceramic capacitor according to claim 1, wherein each of the external electrodes includes a base electrode layer and a plating layer on the base electrode layer.

11. A multilayer ceramic capacitor comprising:
a multilayer body including a plurality of dielectric layers and a plurality of internal electrode layers that are laminated; and external electrodes each being electrically conductive with the internal electrode layers; wherein
the multilayer body includes a first main surface and a second main surface opposed to each other in a lamination direction in which the plurality of dielectric layers and the plurality of internal electrode layers are laminated, a first lateral surface and a second lateral surface opposed to each other in a width direction intersecting both of the lamination direction and a length direction in which each of the plurality of internal electrode layers extends toward a corresponding one of the external electrodes, and a first end surface and a second end surface opposed to each other in the length direction intersecting the lamination direction and the width direction;
each of the external electrodes is on one of the first end surface or the second end surface;
in the multilayer body, when a region where the plurality of internal electrode layers overlap each other when viewed in the lamination direction is an effective portion, opposing regions sandwiching the effective portion in the width direction are a first lateral surface-side outer layer portion and a second lateral surface-side outer layer portion, opposing regions sandwiching the effective portion in the length direction are a first end surface-side outer layer portion and a second end surface-side outer layer portion, and opposing regions sandwiching the effective portion, the first lateral surface-side outer layer portion, the second lateral surface-side outer layer portion, the first end surface-side outer layer portion, and the second end surface-side outer layer portion in the lamination direction are a first main surface-side outer layer portion and a second main surface-side outer layer portion, a pore ratio Pl (%) of the first end surface-side outer layer portion or the second end surface-side outer layer portion and a pore ratio Plt (%) of the first main surface-side outer layer portion or the second main surface-side outer layer portion satisfy about 1.6≤Plt−Pl≤about 3.1.

12. The multilayer ceramic capacitor according to claim 11, wherein, when the multilayer body is viewed in a cross section parallel or substantially parallel to the width direction and the lamination direction at a middle portion in the length direction, a length in the width direction of a range where respective one-side ends of the plurality of internal electrode layers in the width direction are aligned is about 1 μm or more and about 15 μm or less.

13. The multilayer ceramic capacitor according to claim 11, wherein, when the multilayer body is viewed in a cross section parallel or substantially parallel to the width direction and the lamination direction at a middle portion in the length direction, a length Ew in the width direction of one of the plurality of internal electrode layers at a middle portion in the lamination direction and a length Es in the width direction of one of the plurality of internal electrode layers closest to the first main surface or the second main surface satisfy about 95≤Es/Ew×100≤about 101.

14. The multilayer ceramic capacitor according to claim 11, wherein
a dimension in the length direction of the multilayer body is about 0.2 mm or more and about 10 mm or less;
a dimension in the lamination direction of the multilayer body is about 0.1 mm or more and about 10 mm or less; and
a dimension in the width direction of the multilayer body is about 0.2 mm or more and about 10 mm or less.

15. The multilayer ceramic capacitor according to claim 11, wherein each of the plurality of dielectric layers includes BaTiO₃ as a main component.

16. The multilayer ceramic capacitor according to claim 15, wherein each of the plurality of dielectric layers includes a Mn compound, Fe compound, Cr compound, Co compound, or Ni compound as a secondary component.

17. The multilayer ceramic capacitor according to claim 11, wherein a thickness of each of the plurality of dielectric layers is about 0.5 μm or more and about 72 μm or less.

18. The multilayer ceramic capacitor according to claim 11, wherein each of the plurality of internal electrode layers includes at least one of Ni, Cu, Ag, Pd, or Au, or an alloys including at least one of Ni, Cu, Ag, Pd, or Au.

19. The multilayer ceramic capacitor according to claim 11, wherein a thickness of each of the plurality of internal electrode layers is about 0.2 μm or more and about 3.0 μm or less.

20. The multilayer ceramic capacitor according to claim 11, wherein each of the external electrodes includes a base electrode layer and a plating layer on the base electrode layer.
